(19) United States
(12) Patent Application Publication
(10) Pub. No.: US 2024/0040655 A1
(43) Pub. Date: Feb. 1, 2024

(54) PARAMETER CONFIGURATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Qianxi LU, Dongguan (CN); Boyuan Zhang, Dongguan (CN); Bingxue LENG, Dongguan (CN)

(21) Appl. No.: 18/482,494

(22) Filed: Oct. 6, 2023

Related U.S. Application Data
(63) Continuation of application No. PCT/CN2022/080970, filed on Mar. 15, 2022.

(30) Foreign Application Priority Data
Apr. 9, 2021 (CN) 202110385402.8

(51) Int. Cl. H04W 76/20; H04B 17/318

(52) U.S. Cl. CPC H04W 76/20; H04B 17/328

(57) ABSTRACT

A parameter configuration method is applied to a remote terminal and includes: according to a network coverage condition and/or a radio resource control (RRC) state of a remote terminal, determining a parameter used by the remote terminal.

### CROSS-REFERENCE TO RELATED APPLICATION(S)

This application is a continuation of International Application No. PCT/CN2022/080970, filed Mar. 15, 2022, which claims priority to Chinese Patent Application No. 202110385402.8, filed Apr. 9, 2021, the entire disclosure of which is incorporated herein by reference.

### TECHNICAL FIELD

This application relates to the field of communications, and more particularly, to a parameter configuration method, a terminal device, and a network device.

### BACKGROUND

Device-to-device communication is a D2D-based sidelink (SL) transmission technology. Different from the traditional cellular system in which communication data is received or sent through the base station, the Internet of Vehicles system adopts terminal-to-terminal direct communication, so it has higher spectral efficiency and lower transmission delay.

In Rel-13 ProSe, the UE-to-network relay function based on layer 3 relay is introduced, that is, a remote UE accesses the network through a relay UE, the relay UE assumes the function of IP layer relay and transfers data between the remote UE and the network, and the remote UE and the relay UE are connected through a sidelink. In Rel-15 FeD2D, the 3rd Generation Partnership Project (3GPP) discusses the UE-to-network relay function based on layer 2 relay, that is, a remote UE accesses the network through a relay UE, the relay UE assumes the function of the adaptation layer relay (above the RLC layer and below the PDCP layer) and transfers data between the remote UE and the network, and the remote UE and the relay UE are connected through a sidelink. However, this part of work has not been standardized thereafter.

After the introduction of sidelink relays, how to configure parameters in new scenarios is a problem that needs to be solved.

### SUMMARY

Embodiments of this application provide a parameter configuration method, a terminal device, and a network device, which can implement parameter configuration in different scenarios.

Some embodiments of this application propose a parameter configuration method, which is applicable to a remote terminal, including: determining a parameter used by the remote terminal according to a network coverage status and/or a radio resource control (RRC) state of the remote terminal.

Some embodiments of this application also propose a parameter configuration method, which is applicable to a relay terminal, including:
determining, by the relay terminal, whether to perform parameter forwarding for a remote terminal according to a network coverage status and/or an RRC state of the remote terminal.

Some embodiments of this application also propose a parameter configuration method, which is applicable to a remote terminal, including:
sending, to a relay terminal, a network coverage status and/or an RRC state of the remote terminal.

Some embodiments of this application also propose a parameter configuration method, which is applicable to a network device, including:
determining, by the network device, whether to send a parameter for a remote terminal according to a network coverage status and/or an RRC state of the remote terminal.

Some embodiments of this application also propose a parameter configuration method, which is applicable to a remote terminal, including:
sending a network coverage status and/or an RRC state of the remote terminal over network.

Some embodiments of this application further propose a terminal device, the terminal device serves as a remote terminal and includes:
a first determining module, configured to determine a parameter used by the terminal device according to a network coverage status and/or an RRC state of the terminal device.

Some embodiments of this application also propose a terminal device, the terminal device serves as a relay terminal and includes:
a second determining module, configured to determine whether to perform parameter forwarding for a remote terminal according to a network coverage status and/or an RRC state of the remote terminal.

Some embodiments of this application further propose a terminal device, the terminal device serves as a remote terminal and includes:
a first sending module, configured to send, to a relay terminal, a network coverage status and/or an RRC state of the terminal device.

Some embodiments of this application also propose a network device, including:
a third determining module, configured to determine whether to send a parameter for a remote terminal according to a network coverage status and/or an RRC state of the remote terminal.

Some embodiments of this application further propose a terminal device, the terminal device serves as a remote terminal and includes:
a second sending module, configured to send a network coverage status and/or an RRC state of the terminal device over network.

Some embodiments of this application further propose a terminal device, including: a processor, a memory, and a transceiver, where the memory is configured to store a computer program, and the processor, through invoking and executing the computer program stored in the memory and controlling the transceiver, is configured to implement the method according to any embodiments described above.

Some embodiments of this application further propose a network device, including: a processor, a memory, and a transceiver, where the memory is configured to store a computer program, and the processor, through invoking and executing the computer program stored in the memory and controlling the transceiver, is configured to implement the method according to any embodiments described above.

Some embodiments of this application further propose a chip, including: a processor, configured to invoke and execute a computer program from a memory, thereby causing a device installed with the chip to implement the method according to any embodiments described above.

Some embodiments of this application further provide a computer-readable storage medium for storing a computer program, and the computer program causes a computer to implement the method according to any embodiments described above.

Some embodiments of this application also provide a computer program product, including computer program instructions, and the computer program instructions cause a computer to implement the method according to any embodiments described above.

Some embodiments of this application also provide a computer program, and the computer program enables a computer to implement the method according to any embodiments described above.

In some embodiments of this application, parameters used by the remote terminal are determined according to the network coverage status and/or the RRC state of the remote terminal, thereby realizing parameter configuration in different scenarios.

### BRIEF DESCRIPTION OF THE DRAWINGS

FIG. 1A exemplarily shows transmission mode A of the sidelink transmission technique.

FIG. 1B exemplarily shows transmission mode B of the sidelink transmission technique.

FIG. 2 is a schematic flowchart of a parameter configuration method 200 according to some embodiments of this application.

FIG. 3 is a schematic flowchart of Example 1 of this application.

FIG. 4 is a schematic flowchart of Example 2 of this application.

FIG. 5 is a schematic flowchart of a parameter configuration method 500 according to some embodiments of this application.

FIG. 6 is a schematic flowchart of a parameter configuration method 600 according to some embodiments of this application.

FIG. 7 is a schematic flowchart of Example 3 of this application.

FIG. 8 is a schematic flowchart of a parameter configuration method 800 according to some embodiments of this application.

FIG. 9 is a schematic flowchart of a parameter configuration method 900 according to some embodiments of this application.

FIG. 10 is a schematic block diagram of a terminal device 1000 according to some embodiments of this application.

FIG. 11 is a schematic block diagram of a terminal device 1100 according to some embodiments of this application.

FIG. 12 is a schematic block diagram of a terminal device 1200 according to some embodiments of this application.

FIG. 13 is a schematic block diagram of a terminal device 1300 according to some embodiments of this application.

FIG. 14 is a schematic block diagram of a terminal device 1400 according to some embodiments of this application.

FIG. 15 is a schematic block diagram of a network device 1500 according to some embodiments of this application.

FIG. 16 is a schematic block diagram of a network device 1600 according to some embodiments of this application.

FIG. 17 is a schematic block diagram of a terminal device 1700 according to some embodiments of this application.

FIG. 18 is a schematic block diagram of a communication device 1800 according to some embodiments of this application.

FIG. 19 is a schematic block diagram of a chip 1900 according to some embodiments of this application.

### DETAILED DESCRIPTION

The technical solutions in some embodiments of this application will be described below with reference to the accompanying drawings in some embodiments of this application.

It should be noted that the terms “first” and “second” in the description and claims according to some embodiments of this application and the above drawings are used to distinguish similar objects, and are not necessarily used to describe a specific order or sequence. Also, the objects described by “first” and “second” may be the same or different.

The technical solutions according to some embodiments of this application can be applicable to various communication systems, for example: Global System of Mobile communication (GSM) system, Code Division Multiple Access (CDMA) system, Wideband Code Division Multiple Access (WCDMA) system, General Packet Radio Service (GPRS), Long Term Evolution (LTE) system, Advanced Long Term Evolution (LTE-A) system, New Radio (NR) system, evolution system of NR system, LTE-based access to unlicensed spectrum (LTE-U) system, NR-based access to unlicensed spectrum (NR-U) system, Universal Mobile Telecommunication System (UMTS), Wireless Local Area Networks (WLAN), Wireless Fidelity (WiFi), 5th-Generation (5G) system, or other communication systems, etc.

Generally speaking, traditional communication systems support a limited number of connections and are easy to be implemented. However, with the development of communication technology, mobile communication systems will not only support traditional communication, but also support, for example, Device to Device (D2D) communication, Machine to Machine (M2M) communication, Machine Type Communication (MTC), Vehicle to Vehicle (V2V) communication, and the like. Some embodiments of this application can also be applicable to these communications system.

Optionally, the communication system in some embodiments of this application may be applicable to a Carrier Aggregation (CA) scenario, may also be applicable to a Dual Connectivity (DC) scenario, and may also be applicable to a Standalone (SA) networking scenario.

Embodiments of this application does not limit the applied spectrum. For example, some embodiments of this application may be applicable to licensed spectrum, and may also be applicable to unlicensed spectrum.

Some embodiments of this application describe various embodiments in conjunction with network device and terminal device. The terminal device may also be referred to as user equipment (UE), access terminal, subscriber unit, subscriber station, mobile station, mobile site, remote station, remote terminal, mobile device, user terminal, terminal, wireless communication device, user agent or user device, and the like. The terminal device may be a station (ST) in the WLAN, and may also be a cellular phone, a cordless phone, a Session Initiation Protocol (SIP) phone, a Wireless Local Loop (WLL) station, a Personal Digital Assistant (PDA) device, a handheld device with wireless communication capabilities, a computing device or other processing devices connected to wireless modems, an in-vehicle device, a wearable device, a terminal device in the next-generation communication system, such as in NR network, a terminal device in the future-evolved Public Land Mobile Network (PLMN) network, or the like.

As an example without limitation, in some embodiments of this application, the terminal device may also be a wearable device. Wearable devices may also be called wearable smart devices, which are the general term for the intelligent design of daily wear and the development of wearable devices using wearable technology, such as glasses, gloves, watches, clothing and shoes. Wearable device is a portable device that is worn directly on the body or integrated into the user's clothing or accessories. Wearable device is not only a hardware device, but also realizes powerful functions through software support, data interaction, and cloud interaction. In a general sense, wearable smart devices may be of full-feature, large-scale, with complete or partial functions without relying on smart phones, including such as smart watches or smart glasses; or may only focus on a certain type of application function, which needs to cooperate with other devices such as smart phones, including such as various smart bracelets, and smart jewelry for physical sign monitoring.

The network device may be a device for communicating with a mobile device. For example, the network device may be an access point (AP) in WLAN, or a base transceiver station (BTS) in GSM or CDMA, a NodeB (NB) in WCDMA, an evolutional Node B (eNB or eNodeB) in LTE, a relay station, an access point, an in-vehicle device, a wearable device, a network device (gNB) in NR network, a network device in the future-evolved PLMN network, or the like.

In some embodiments of this application, the network device provides services for a cell, and the terminal device communicates with the network device through transmission resources (e.g., frequency domain resources, or spectrum resources) used by the cell, and the cell may be a cell corresponding to the network device (e.g., base station). The cell may belong to a macro base station, or may belong to a base station corresponding to a small cell, where the small cell may include a metro cell, a micro cell, a pico cell, a femto cell, and the like. These small cells have the characteristics of small coverage and low transmit power, and are suitable for providing high-speed data transmission services.

It should be understood that the terms “system” and “network” are often used interchangeably herein. The term “and/or” in this article is only used to describe an association relationship of associated objects, indicating that there may be three kinds of relationships. For example, as to “A and/or B”, it may mean three cases: A exists alone, both A and B exist, and B exists alone. In addition, the character “I” in this document generally indicates that the related objects are in an “or” relationship.

It should be understood that the “indication” mentioned in some embodiments of this application may be a direct indication, an indirect indication, or may represent presence of an associated relationship. For example, if A indicates B, it may mean that A directly indicates B, for example, B can be acquired through A; it may also mean that A indicates B indirectly, for example, A indicates C, and B can be acquired through C; it may also mean that there is an associated relationship between A and B.

In the description of some embodiments of this application, the term “corresponding” may indicate that there is a direct or indirect correspondence between two objects, or may indicate that there is an associated relationship, or a relationship of indicating and being indicated, or a relationship of configuring and being configured, between the two objects.

In order to facilitate the understanding of the technical solutions according to some embodiments of this application, the related technologies of some embodiments of this application are described below. The following related technologies can be arbitrarily combined with the technical solutions according to some embodiments of this application as optional solutions, which should fall within the protection scope of some embodiments of this application.

Device-to-device communication is a D2D-based sidelink transmission technology. Different from the traditional cellular system in which communication data is received or sent through the base station, the IoV system adopts terminal-to-terminal direct communication, so it has higher spectral efficiency and lower transmission delay. Two transmission modes are defined in 3GPP: mode A and mode B.

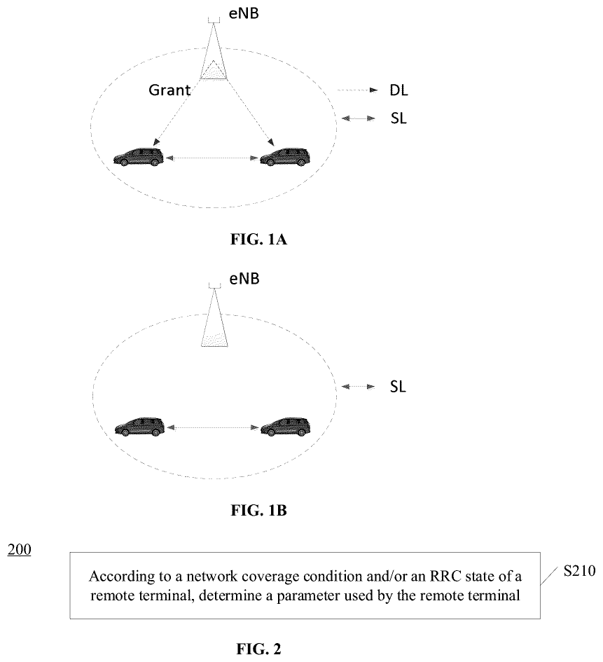

FIG. 1A exemplarily shows transmission mode A of the sidelink transmission technique. In mode A, the transmission resources of the terminal are allocated by the base station, and the terminal transmits data on the sidelink according to the resources allocated by the base station; the base station may allocate resources for a single transmission to the terminal, or may allocate semi-static transmission resources to the terminal. FIG. 1B exemplarily shows transmission mode B of the sidelink transmission technique. In mode B, the in-vehicle terminal selects a resource in the resource pool for data transmission.

In 3GPP, D2D is divided into the following different stages for research.

The first stage is related to Proximity based Service (ProSe). In Rel-12/13, the D2D communication is studied for the ProSe scenario, which is mainly aimed at public safety services. In ProSe, by configuring the time-domain position of the resource pool, for example, the resource pool is non-consecutive in the time domain, the UE may send/receive data non-consecutively on the sidelink, thereby achieving the effect of power saving.

The second stage is related to the Internet of Vehicles (V2X). In Rel-14/15, the V2X system is studied for the scenario of vehicle-to-vehicle communication, which is mainly oriented to the services of relatively high-speed moving vehicle-to-vehicle and vehicle-to-person communication. In V2X, since the vehicle system has continuous power supply, power efficiency is not the main problem, but the delay of data transmission is the main problem. Therefore, the terminal device is required to perform continuous transmission and reception in system design.

The third stage is related to wearable device (FeD2D). In Rel-14, this scenario studies the scenario of wearable device accessing the network through a mobile phone, which is mainly oriented to the scenario of low mobile speed and low power access. In FeD2D, the 3GPP conclusion in the pre-research stage is that the base station may configure the DRX parameters of a remote terminal through a relay terminal, but there is no conclusion about the specific details of how to perform the DRX configuration.

On the basis of LTE 2X, NR V2X is not limited to broadcast scenario, but is further extended to unicast and multicast scenarios, where V2X applications are studied. Similar to LTE V2X, two resource grant modes are also defined in NR V2X. Further, users may be in a mixed mode, that is, they can use mode-1 for resource acquisition and, at the same time, use mode-2 for resource acquisition.

In Rel-13 ProSe, the UE-to-network relay function based on layer-3 relay is introduced, that is, a remote UE accesses the network through a relay UE, where the relay UE undertakes the function of IP layer relay, and transfers data between the remote UE and the network, and the remote UE and the relay UE are connected through a sidelink. In Rel-15 FeD2D, the 3rd Generation Partnership Project (3GPP) studied the UE-to-network relay function based on layer-2 relay, that is, the remote UE accesses the network through the relay UE, where the relay UE undertakes the function of the adaptation layer (above the RLC layer and below the PDCP layer) relay, and transfers data between the remote UE and the network, and the remote UE and the relay UE are connected through a sidelink. However, this part of the work has not been standardized subsequently.

Before the introduction of sidelink relay technology, the principles of sidelink parameter configuration are as follows:
1. for users outside the coverage of direct network connection, pre-configured parameters are used;
2. for users in the RRC idle state (IDLE)/inactive state (INACTIVE) within the coverage of direct network connection, parameters broadcast in the System Information Block (SIB, system message) are used;
3. for users in the RRC connected state (CONNECTED) within the coverage of network direct connection, parameters configured by the dedicated RRC signaling are used.

Herein, above 1/2/3 are for different scenarios and are not related to each other.

After the introduction of sidelink relay, users may be outside the coverage of direct network connection and in RRC IDLE/INACTIVE at the same time, and users may also be outside the coverage of direct network connection and in RRC CONNECTED at the same time. In this case, the original sidelink parameter configuration principle cannot be used for parameter configuration. Therefore, how to configure parameters in the new scenario is a problem that needs to be solved.

Some embodiments of this application propose a parameter configuration method. FIG. 2 is a schematic flowchart of a parameter configuration method 200 according to some embodiments of this application. The method is applicable to a remote terminal, a relay terminal or a network device in a sidelink relay system, but not limited thereto. The method includes at least some of the following.

In S210, a parameter used by the remote terminal is determined according to a network coverage status and/or an RRC state of the remote terminal.

In some embodiments of this application, the principles of parameter configuration may include at least the following two.

First, in the case where the remote terminal is outside the network coverage and the remote terminal is outside the relay coverage, it is determined that the remote terminal adopts a preconfigured parameter(s). In other cases, based on the RRC state of the remote terminal, it is determined to adopt a parameter(s) broadcast in the SIB or a parameter(s) configured by the RRC signaling.

Second, in the case that the remote terminal is outside the network coverage, it is determined that the remote terminal adopts the preconfigured parameter(s). When the remote terminal is within the network coverage, it is determined to adopt the parameter(s) broadcast in the SIB or the parameter(s) configured by RRC signaling based on the RRC state of the remote terminal.

In some embodiments, the situation that the remote terminal is within the network coverage may be that the strength and/or quality of the signal received by the remote terminal from the network device is equal to or higher than a predetermined threshold.

The situation that the remote terminal is outside the network coverage may be that the strength and/or quality of the signal received by the remote terminal from the network device is equal to or lower than the predetermined threshold.

The situation that the remote terminal is within the relay coverage (or non-direct connection coverage) may be: the strength and/or quality of the signal received by the remote terminal from the relay terminal is equal to or higher than a predetermined threshold.

The situation that the remote terminal is outside the relay coverage (or non-direct connection coverage) may be: the strength and/or quality of the signal received by the remote terminal from the relay terminal is equal to or lower than a predetermined threshold.

The above cases where the remote terminal is within/outside the network coverage and the remote terminal is within/outside the relay coverage are just examples, which are not limited in this application.

The above two parameter configuration principles are described in detail below.

The first principle includes at least the following.
1. In the case that the remote terminal is outside the network coverage and the remote terminal is outside the relay coverage, it is determined that the remote terminal adopts the preconfigured parameter(s).
2. When the remote terminal satisfies at least one of the following conditions, it is determined that the remote terminal adopts the parameter(s) broadcast in SIB:
(1) the remote terminal is within the network coverage and/or the relay coverage;
(2) the remote terminal is in the RRC idle state or the RRC inactive state; and
(3) The remote terminal has obtained the parameter(s) broadcast in the SIB.

In this case, further, when the remote terminal is within the relay coverage, the above-mentioned SIB may be an SIB relayed by the relay terminal.
3. When the remote terminal satisfies at least one of the following conditions, it is determined that the remote terminal adopts the parameter(s) configured by using the dedicated RRC signaling:
(1) the remote terminal is within the network coverage and/or the relay coverage;
(2) the remote terminal is in the RRC connected state; and
(3) the remote terminal has obtained the parameter(s) configured by the dedicated RRC signaling.

In this case, further, when the remote terminal is within the relay coverage, the above-mentioned dedicated RRC signaling may be a dedicated RRC signaling relayed by the relay terminal.

The second principle includes at least the following.
1. When the remote terminal is outside the network coverage, it is determined that the remote terminal adopts the preconfigured parameter(s).
2. When the remote terminal satisfies the following conditions, it is determined that the remote terminal adopts the parameter(s) broadcast in the SIB:
(1) the remote terminal is within the network coverage; and,
(2) the remote terminal is in the RRC idle state or the RRC inactive state.

In this case, further, when the remote terminal is within the network coverage and the remote terminal is in the non-direct connection state, the above-mentioned SIB may be an SIB relayed by the relay terminal.
3. When the remote terminal is within the network coverage and the remote terminal is in the RRC connected state, it is determined that the remote terminal adopts the parameter(s) configured by using the dedicated RRC signaling.

In this case, further, when the remote terminal is within the network coverage and the remote terminal is in the non-direct connection state, the above-mentioned dedicated RRC signaling may be a dedicated RRC signaling relayed by the relay terminal.

In some embodiments of this application, the remote terminal, the relay terminal, or the network device may perform the above step of determining parameter(s). If the above step of determining parameter(s) is performed by the remote terminal, after the parameter(s) is determined, the remote terminal further uses the determined parameter(s). For example, the above approach further includes:
the remote terminal receives SIB and/or dedicated RRC signaling;
if it is determined that the remote terminal uses the parameter(s) broadcast in the SIB, the parameter(s) broadcast in the received SIB is used; if it is determined that the remote terminal uses the parameter(s) configured by the dedicated RRC signaling, the parameter(s) configured by received dedicated RRC signaling is used; if it is determined that the remote terminal adopts the pre-configured parameter(s), the pre-configured parameter(s) is used.

If the above step of determining parameter(s) is performed by the relay terminal, the relay terminal determines whether to perform parameter forwarding for the remote terminal according to the network coverage status and/or the RRC state of the remote terminal. For example, if it is determined that the remote terminal should use the pre-configured parameter(s) according to the network coverage status and/or RRC state of the remote terminal, the relay terminal does not forward any data to the remote terminal; if it is determined that the remote terminal should use the parameter(s) broadcast in the SIB according to the network coverage status and/or RRC state of the remote terminal, then the relay terminal performs parameter forwarding through SIB for the remote terminal; if it is determined that the remote terminal should use the parameter(s) configured by the dedicated RRC signaling according to the network coverage status and/or RRC state of the remote terminal, then the relay terminal performs parameter forwarding through the dedicated RRC signaling for the remote terminal.

If the above step of determining parameter(s) is performed by the network device, the relay terminal determines whether to send parameter(s) for the remote terminal according to the network coverage status and/or RRC state of the remote terminal. For example, if it is determined that the remote terminal should use the preconfigured parameter(s) according to the network coverage status and/or RRC state of the remote terminal, the network device does not send parameter(s) for the remote terminal; if it is determined that the remote terminal should use the parameter(s) broadcast in the SIB according to the network coverage status and/or RRC state of the remote terminal, then the network device sends the parameter(s) through SIB for the remote terminal; if it is determined that the remote terminal should use the parameter(s) configured by the dedicated RRC signaling according to the network coverage status and/or RRC state of the remote terminal, then the network device sends the parameter(s) through dedicated RRC signaling to the remote terminal.

Specific embodiments are given below to respectively introduce specific examples of parameter selection performed by the remote terminal, the relay terminal and the network device.

### Example 1

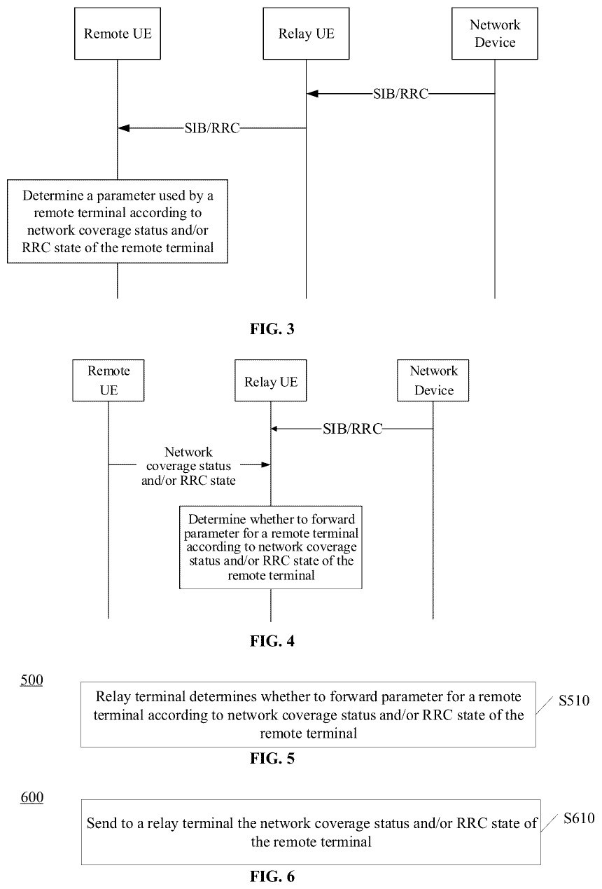

In some embodiments, the remote terminal determines the use of parameter(s). FIG. 3 is a schematic flowchart of Example 1 of this application. As shown in FIG. 3, the network device sends SIB (system message)/dedicated RRC signaling to the relay terminal, and the relay terminal forwards the SIB (system message)/dedicated RRC signaling to the remote terminal. The remote terminal determines the parameter(s) to be used according to the network coverage status and/or RRC state thereof. In addition to the manner shown in FIG. 3, the network device may also directly send the SIB (system message)/dedicated RRC signaling to the remote terminal.

The manner the remote terminal determines the parameter(s) has been introduced in the above parameter configuration principle. Taking the second parameter configuration principle above as an example, if the remote terminal is outside the network coverage, the remote terminal adopts the pre-configured parameter(s); if the remote terminal is within the network coverage and the remote terminal is in RRC IDLE/RRC INACTIVE, the remote terminal adopts the parameter(s) broadcast in the SIB; if the remote terminal is within the network coverage and the remote terminal is in RRC CONNECTED, the remote terminal adopts the parameter(s) configured by the dedicated RRC signaling.

### Example 2

In some embodiments, the relay terminal determines the use of parameter(s). FIG. 4 is a schematic flowchart of Example 2 of this application. As shown in FIG. 4, the remote terminal sends the network coverage status and/or RRC state of itself to the relay terminal, and the network device sends SIB (system message)/dedicated RRC signaling to the relay terminal. Optionally, the remote terminal may send the network coverage status and/or RRC state of the remote terminal to the relay terminal through PC5-RRC signaling or PC5-S signaling.

The relay terminal determines whether to perform parameter forwarding for the remote terminal according to the network coverage status and/or the RRC state of the remote terminal.

The manner for the relay terminal to determine the parameter(s) has been introduced in the above parameter configuration principle. Taking the second parameter configuration principle above as an example, if the remote terminal is outside the network coverage, the relay terminal determines not to perform parameter forwarding for the remote terminal.

If the remote terminal is within the network coverage and the remote terminal is in RRC IDLE/RRC INACTIVE, it is determined to perform parameter forwarding through SIB for the remote terminal, and the relay terminal can forward the SIB parameter(s) received from the network device to the remote terminal. In this case, if the remote terminal is within the network coverage and the remote terminal is in the non-direct connection state, the above-mentioned SIB may be an SIB relayed by the relay terminal.

If the remote terminal is within the network coverage and the remote terminal is in RRC CONNECTED, it is determined to perform parameter forwarding through dedicated RRC signaling for the remote terminal, and the relay terminal can forward the dedicated RRC signaling parameter(s) received from the network device to the remote terminal. In this case, if the remote terminal is within the network coverage and the remote terminal is in the non-direct connection state, the above-mentioned dedicated RRC signaling may be a dedicated RRC signaling relayed by the relay terminal.

Further, a specific implementation manner for the relay terminal to determine whether to perform parameter forwarding for the remote terminal may further include:
in the case that the remote terminal is outside the network coverage and the remote terminal is outside the relay coverage, it is determined that parameter forwarding is not performed for the remote terminal.

If the remote terminal satisfies the following conditions, it is determined to forward SIB parameter(s) for the remote terminal:
the remote terminal is within the network coverage and/or relay coverage; and
the remote terminal is in the RRC idle state or the RRC inactive state.

Optionally, when the remote terminal is within the relay coverage, the SIB is an SIB relayed by the relay terminal.

If the remote terminal satisfies the following conditions, it is determined to forward the dedicated RRC signaling parameter(s) for the remote terminal:
the remote terminal is within the network coverage and/or relay coverage; and
the remote terminal is in the RRC connected state.

Optionally, when the remote terminal is within the relay coverage, the dedicated RRC signaling is a dedicated RRC signaling relayed by the relay terminal.

Corresponding to Example 2, this application proposes a parameter configuration method, which is applicable to a relay terminal. FIG. 5 is a schematic flowchart of a parameter configuration method 500 according to some embodiments of this application, including the following content.

In S510, the relay terminal determines whether to perform parameter forwarding for the remote terminal according to the network coverage status and/or the RRC state of the remote terminal.

The specific determination method and related content have been introduced in Example 2 and the above-mentioned parameter configuration principles, and will not be repeated here.

Moreover, corresponding to Example 2, this application also proposes a parameter configuration method, which is applicable to a remote terminal. FIG. 6 is a schematic flowchart of a parameter configuration method 600 according to some embodiments of this application, including the following content.

In S610, the network coverage status and/or RRC state of the remote terminal is sent to the relay terminal.

The above-mentioned network coverage status and/or RRC state sent to the relay terminal can be used by the relay terminal to determine whether to perform parameter forwarding for the remote terminal. Optionally, the remote terminal sends the network coverage status and/or RRC state of the remote terminal to the relay terminal through PC5-RRC signaling or PC5-S signaling.

Optionally, when the remote terminal is outside the network coverage and the remote terminal is outside the relay coverage, the network coverage status is used for the relay terminal to determine not to perform parameter forwarding for the remote terminal. Optionally, the above-mentioned situation that the remote terminal is outside the relay coverage includes: the strength and/or quality of the signal received by the remote terminal from the relay terminal is equal to or lower than a predetermined threshold.

Optionally, when the remote terminal is within the network coverage and/or the relay coverage, and the remote terminal is in the RRC idle state or the RRC inactive state, the network coverage status and the RRC state are used for the relay terminal to determine to forward the SIB parameter(s) for the remote terminal. Optionally, when the remote terminal is within the relay coverage, the SIB is an SIB relayed by the relay terminal.

Optionally, when the remote terminal is within the network coverage and/or the relay coverage, and the remote terminal is in the RRC connected state, the above-mentioned network coverage status and RRC state are used for the relay terminal to determine to forward the dedicated RRC signaling parameter(s) for the remote terminal.

Optionally, when the remote terminal is within the relay coverage, the above-mentioned dedicated RRC signaling is a dedicated RRC signaling relayed by the relay terminal.

Optionally, the above-mentioned situation that the remote terminal is within the relay coverage includes: the strength and/or quality of the signal received by the remote terminal from the relay terminal is equal to or higher than a predetermined threshold.

Optionally, when the remote terminal is outside the network coverage, the above-mentioned network coverage status is used for the relay terminal to determine not to perform parameter forwarding for the remote terminal.

Optionally, the situation that the remote terminal is outside the network coverage includes: the strength and/or quality of the signal received by the remote terminal from the network device is equal to or lower than a predetermined threshold.

Optionally, when the remote terminal is within the network coverage, and the remote terminal is in the RRC idle state or the RRC inactive state, the above-mentioned network coverage status and RRC state are used for the relay terminal to determine to forward the SIB parameter(s) for the remote terminal.

Optionally, when the remote terminal is within the network coverage and the remote terminal is in a non-direct connection state, the above-mentioned SIB is an SIB transferred by the relay terminal.

Optionally, when the remote terminal is within the network coverage and the remote terminal is in the RRC connected state, the above-mentioned network coverage status and RRC state are used for the relay terminal to determine to forward the dedicated RRC signaling parameter(s) for the remote terminal.

Optionally, when the remote terminal is within the network coverage and the remote terminal is in a non-direct connection state, the above-mentioned dedicated RRC signaling is a dedicated RRC signaling relayed by the relay terminal.

Optionally, the situation that the remote terminal is within the network coverage includes: the strength and/or quality of the signal received by the remote terminal from the network device is equal to or higher than a predetermined threshold.

### Example 3

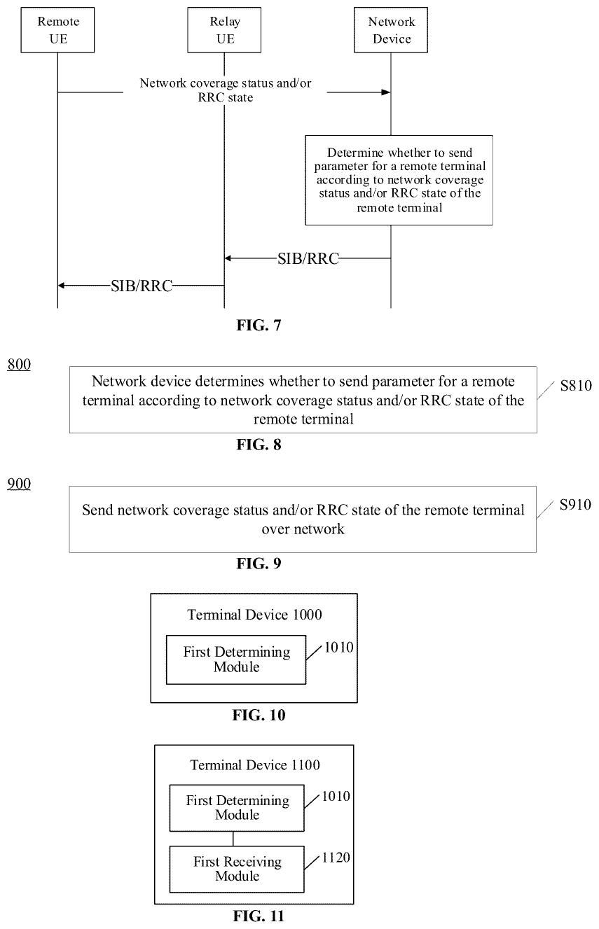

In some embodiments, the network device determines the use of parameter(s). FIG. 7 is a schematic flowchart of Example 3 of this application. As shown in FIG. 7, the remote terminal sends the network coverage status and/or RRC state thereof to the network. The remote terminal may report its own network coverage status and/or RRC state to the base station (gNB) by means of relay. The remote terminal may also report its own network coverage status and/or RRC state to the relay terminal through PC5-RRC signaling/SL MAC CE/physical layer signaling, and then the relay terminal reports the same to the base station by means of SUI or the like. Alternatively, the remote terminal may directly send its own network coverage status and/or RRC state to the network device.

The network device determines whether to send parameter(s) for the remote terminal according to the network coverage status and/or the RRC state of the remote terminal.

The manner for determining parameter(s) by the network device has been introduced in the above-mentioned parameter configuration principles. Taking the above-mentioned second parameter configuration principle as an example, if the remote terminal is outside the network coverage, the network device determines not to send parameter(s) to the remote terminal.

If the remote terminal is within the network coverage and the remote terminal is in RRC IDLE/RRC INACTIVE, the network device may send SIB parameter(s) for the remote terminal. In this case, if the remote terminal is within the network coverage and the remote terminal is in a non-direct connection state, the above-mentioned SIB may be an SIB relayed by the relay terminal.

If the remote terminal is within the network coverage and the remote terminal is in RRC CONNECTED, the network device may send dedicated RRC signaling parameter(s) for the remote terminal. In this case, if the remote terminal is within the network coverage and the remote terminal is in a non-direct connection state, the above-mentioned dedicated RRC signaling may be a dedicated RRC signaling relayed by the relay terminal.

Further, a specific implementation manner for the network device to determine whether to send parameter(s) for the remote terminal may further include:
in the case that the remote terminal is outside the network coverage and the remote terminal is outside the relay coverage, it is determined not to send parameter(s) for the remote terminal.

If the remote terminal satisfies the following conditions, it is determined to send the SIB parameter(s) for the remote terminal:
the remote terminal is within the network coverage and/or relay coverage; and
the remote terminal is in the RRC idle state or the RRC inactive state.

Optionally, when the remote terminal is within the relay coverage, the SIB is an SIB relayed by the relay terminal.

If the remote terminal satisfies the following conditions, it is determined to send the dedicated RRC signaling parameter(s) for the remote terminal:
the remote terminal is within the network coverage and/or relay coverage; and
the remote terminal is in the RRC connected state.

Optionally, when the remote terminal is within the relay coverage, the dedicated RRC signaling is a dedicated RRC signaling relayed by the relay terminal.

Corresponding to Example 3, this application proposes a parameter configuration method, which is applicable to a network device. FIG. 8 is a schematic flowchart of a parameter configuration method 800 according to some embodiments of this application, including the following content.

In S810, the network device determines whether to send parameter(s) for the remote terminal according to the network coverage status and/or the RRC state of the remote terminal.

The specific determination method and related content have been introduced in Example 3 and the above-mentioned parameter configuration principles, and will not be repeated here.

Optionally, the above method may further include:
the network device receives the network coverage status and/or RRC state of the remote terminal.

Optionally, the network device receives the network coverage status and/or the RRC state of the remote terminal from the remote terminal or the relay terminal.

The network device may receive, from the relay terminal, the network coverage status and/or RRC state of the remote terminal that is transparently transmitted by the relay terminal; or, the network device may receive the network coverage status and/or RRC state of the remote terminal sent by the relay terminal in the SUI manner.

Moreover, corresponding to Example 3, this application also proposes a parameter configuration method, which is applicable to a remote terminal. FIG. 9 is a schematic flowchart of a parameter configuration method 900 according to some embodiments of this application, including the following content.

In S910, the network coverage status and/or RRC state of the remote terminal is sent to the network.

The above-mentioned network coverage status and/or RRC state sent to the network can be used by the network device to determine whether to send parameter(s) for the remote terminal.

Optionally, in the above S910, the remote terminal may send the network coverage status and/or RRC state of the remote terminal to the relay terminal through PC5-RRC signaling or PC5-S signaling. Afterwards, the relay terminal may send the network coverage status and/or the RRC state of the remote terminal to the network device.

Alternatively, in the above step S910, the remote terminal may send the network coverage status and/or RRC state of the remote terminal to the network device through physical layer signaling, MAC CE or RRC signaling.

Optionally, the above-mentioned RRC signaling includes sidelink UE information.

Optionally, when the remote terminal is outside the network coverage and the remote terminal is outside the relay coverage, the network coverage is used for the network device to determine not to send parameter(s) for the remote terminal.

Optionally, the above-mentioned situation that the remote terminal is outside the relay coverage includes: the strength and/or quality of the signal received by the remote terminal from the relay terminal is equal to or lower than a predetermined threshold.

Optionally, when the remote terminal is within the network coverage and/or the relay coverage, and the remote terminal is in the RRC idle state or the RRC inactive state, the above-mentioned network coverage status and RRC state are used for the network device to determine to send the SIB parameter(s) for the remote terminal.

Optionally, when the remote terminal is within the relay coverage, the above-mentioned SIB is an SIB relayed by the relay terminal.

Optionally, when the remote terminal is within the network coverage and/or the relay coverage, and the remote terminal is in the RRC connected state, the above-mentioned network coverage status and RRC state are used for the network device to determine to send the dedicated RRC signaling parameter(s) for the remote terminal.

Optionally, when the remote terminal is within the relay coverage, the above-mentioned dedicated RRC signaling is a dedicated RRC signaling relayed by the relay terminal.

Optionally, the situation that the remote terminal is within the relay coverage includes: the strength and/or quality of the signal received by the remote terminal from the relay terminal is equal to or higher than a predetermined threshold.

Optionally, when the remote terminal is outside the network coverage, the above-mentioned network coverage status is used for the network device to determine not to send parameter(s) for the remote terminal.

Optionally, the situation that the remote terminal is outside the network coverage includes: the strength and/or quality of the signal received by the remote terminal from the network device is equal to or lower than a predetermined threshold.

Optionally, when the remote terminal is within the network coverage, and the remote terminal is in the RRC idle state or the RRC inactive state, the above-mentioned network coverage status and RRC state are used for the network device to determine to send the SIB parameter(s) for the remote terminal.

Optionally, when the remote terminal is within the network coverage and the remote terminal is in a non-direct connection state, the above-mentioned SIB is an SIB relayed by the relay terminal.

Optionally, when the remote terminal is within the network coverage and the remote terminal is in the RRC connected state, the above-mentioned network coverage status and RRC state are used for the network device to determine to send the dedicated RRC signaling parameter(s) for the remote terminal.

Optionally, when the remote terminal is within the network coverage and the remote terminal is in a non-direct connection state, the above-mentioned dedicated RRC signaling is a dedicated RRC signaling relayed by the relay terminal.

Optionally, the situation that the remote terminal is within the network coverage includes: the strength and/or quality of the signal received by the remote terminal from the network device is equal to or higher than a predetermined threshold.

To sum up, this application designs a mechanism for configuring parameter(s) in different scenarios according to a new coverage status in the relay-supported sidelink network. The remote terminal, the relay terminal or the network device may select the parameter(s) to be used by the remote terminal according to the network coverage status and/or the RRC state of the remote terminal. If it is selected by the relay terminal, the relay terminal determines whether to perform parameter forwarding for the remote terminal; the terminal device may need to send its own network coverage status and/or RRC state to the relay terminal for the relay terminal to perform parameter selection. If it is selected by the network device, the network device determines whether to send parameter(s) to the remote terminal; the terminal device may need to send its own network coverage status and/or RRC state to the network for the network device to perform parameter selection.

Some embodiments of this application also propose a terminal device, which can be used as a remote terminal. FIG. 10 is a schematic block diagram of a terminal device 1000 according to some embodiments of this application, including:
a first determination module 1010, configured to determine a parameter used by the terminal device according to a network coverage status and/or an RRC state of the terminal device.

Optionally, the above-mentioned first determination model 1010 is configured to, in response to the terminal device being outside a network coverage and outside a relay coverage, determine that the terminal device uses a preconfigured parameter.

Optionally, the above-mentioned situation in which the terminal device is outside the relay coverage includes:
a strength and/or quality of signal received by the terminal device from a relay terminal is equal to or lower than a predetermined threshold.

Optionally, the above-mentioned first determination model 1010 is configured to, in response to the terminal device satisfying at least one of following conditions, determine that the terminal device uses a parameter broadcast in SIB:
the terminal device is within a network coverage and/or a relay coverage;
the terminal device is in an RRC idle state or an RRC inactive state; and
the terminal device has acquired the parameter(s) broadcast in the SIB.

Optionally, when the terminal device is within the relay coverage, the SIB is an SIB relayed by the relay terminal.

Optionally, the above-mentioned first determination model 1010 is configured to, in response to the terminal device satisfying at least one of the following conditions, determine that the terminal device uses a parameter configured by a dedicated RRC signaling:
the terminal device is within a network coverage and/or a relay coverage;
the terminal device is in an RRC connected state; and
the terminal device has acquired the parameter(s) configured by the dedicated RRC signaling.

Optionally, when the terminal device is within the relay coverage, the dedicated RRC signaling is a dedicated RRC signaling relayed by the relay terminal.

Optionally, the above-mentioned situation that the terminal device is within the relay coverage includes:
a strength and/or quality of signal received by the terminal device from a relay terminal is equal to or higher than a predetermined threshold.

Optionally, the above-mentioned first determination model 1010 is configured to, in response to the terminal device being outside a network coverage, determine that the terminal device uses a preconfigured parameter.

Optionally, the above-mentioned situation in which the terminal device is outside the network coverage includes:
a strength and/or quality of signal received by the terminal device from a network device is equal to or lower than a predetermined threshold.

Optionally, the above-mentioned first determination model 1010 is configured to, in response to the terminal device satisfying following conditions, determine that the terminal device uses a parameter broadcast in an SIB:
the terminal device is within a network coverage; and
the terminal device is in an RRC idle state or an RRC inactive state.

Optionally, when the terminal device is within the network coverage and the terminal device is in a non-direct connection state, the SIB is an SIB relayed by the relay terminal.

Optionally, the above-mentioned first determination model 1010 is configured to, in response to the terminal device being within a network coverage and being in an RRC connected state, determine that the terminal device uses a parameter configured by a dedicated RRC signaling.

Optionally, when the terminal device is within the network coverage and the terminal device is in a non-direct connection state, the dedicated RRC signaling is a dedicated RRC signaling relayed by the relay terminal.

Optionally, the above-mentioned situation that the terminal device is within the network coverage includes:
a strength and/or quality of signal received by the terminal device from a network device is equal to or higher than a predetermined threshold.

FIG. 11 is a schematic block diagram of a terminal device 1100 according to some embodiments of this application. The terminal device can be used as a remote terminal. The terminal device 1100 includes the above-mentioned first determination module 1010, and may further include:
a first receiving module 1120, configured to receive the SIB and/or the dedicated RRC signaling.

The above-mentioned first determination module 1010 is further configured to: in response to determining that the terminal device uses a parameter broadcast in the SIB, use the parameter broadcast in the SIB as received; in response to determining that the terminal device uses a parameter configured by a dedicated RRC signaling, use the parameter configured by the dedicated RRC signaling as received; and in response to determining that the terminal device uses a pre-configured parameter, use the pre-configured parameter.

It should be understood that the above and other operations and/or functions of the modules in the terminal device according to some embodiments of this application are respectively configured to implement the corresponding process of the terminal device in the method 200 of FIG. 2, and are not repeated here for brevity.

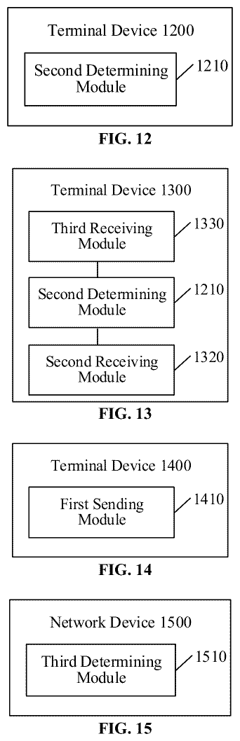

Some embodiments of this application also propose a terminal device, which can be used as a relay terminal. FIG. 12 is a schematic block diagram of a terminal device 1200 according to some embodiments of this application, including:
a second determining module 1210, configured to determine whether to perform parameter forwarding for a remote terminal according to a network coverage status and/or an RRC state of the remote terminal.

Optionally, the above-mentioned second determination model 1210 is configured to, in response to the remote terminal being outside a network coverage and outside a relay coverage, determine not to perform parameter forwarding for the remote terminal.

Optionally, the above-mentioned situation that the remote terminal is outside the relay coverage includes:
a strength and/or quality of signal received by the remote terminal from the relay terminal is equal to or lower than a predetermined threshold.

Optionally, the above-mentioned second determination model 1210 is configured to, in response to the remote terminal satisfying following conditions, determine to perform parameter forwarding through a system information block (SIB) for the remote terminal:
the remote terminal is within a network coverage and/or a relay coverage; and
the remote terminal is in an RRC idle state or an RRC inactive state.

Optionally, when the remote terminal is within the relay coverage, the SIB is an SIB relayed by the relay terminal.

Optionally, the above-mentioned second determination model 1210 is configured to, in response to the remote terminal satisfying following conditions, determine to perform parameter forwarding through a dedicated RRC signaling for the remote terminal:
the remote terminal is within a network coverage and/or a relay coverage; and
the remote terminal is in an RRC connected state.

Optionally, when the remote terminal is within the relay coverage, the dedicated RRC signaling is a dedicated RRC signaling relayed by the relay terminal.

Optionally, the above-mentioned situation that the remote terminal is within the relay coverage includes:
a strength and/or quality of signal received by the remote terminal from the relay terminal is equal to or higher than a predetermined threshold.

Optionally, the above-mentioned second determination model 1210 is configured to, in response to the remote terminal being outside a network coverage, determine not to perform parameter forwarding for the remote terminal.

Optionally, the above-mentioned situation that the remote terminal is outside the network coverage includes:
a strength and/or quality of signal received by the remote terminal from a network device is equal to or lower than a predetermined threshold.

Optionally, the above-mentioned second determination model 1210 is configured to, in response to the remote terminal satisfying following conditions, determine to perform parameter forwarding through an SIB for the remote terminal:
the remote terminal is within a network coverage; and
the remote terminal is in an RRC idle state or an RRC inactive state.

Optionally, when the above-mentioned remote terminal is within the network coverage and the remote terminal is in a non-direct connection state, the SIB is an SIB relayed by the relay terminal.

Optionally, the above-mentioned second determination model 1210 is configured to, in response to the remote terminal being within a network coverage and being in an RRC connected state, determine to perform parameter forwarding through a dedicated RRC signaling for the remote terminal.

Optionally, when the remote terminal is within the network coverage and the remote terminal is in a non-direct connection state, the dedicated RRC signaling is a dedicated RRC signaling relayed by the relay terminal.

Optionally, the situation that the remote terminal is within the network coverage includes: a strength and/or quality of signal received by the remote terminal from a network device is equal to or higher than a predetermined threshold.

FIG. 13 is a schematic block diagram of a terminal device 1300 according to some embodiments of this application. The terminal device can be used as a relay terminal. The terminal device 1300 includes the above-mentioned second determination module 1210, and may further include:
a second receiving module 1320, configured to receive, from the remote terminal, the network coverage status and/or the RRC state of the remote terminal.

Optionally, the above-mentioned terminal device may also include:
a third receiving module 1330, configured to receive, from a network device, an SIB and/or a dedicated RRC signaling associated with the remote terminal.

It should be understood that the above and other operations and/or functions of the modules in the terminal device according to some embodiments of this application are respectively configured to implement the corresponding process of the terminal device in the method 500 of FIG. 5, and are not repeated here for brevity.

Some embodiments of this application also propose a terminal device, which can be used as a remote terminal. FIG. 14 is a schematic block diagram of a terminal device 1400 according to some embodiments of this application, including:
a first sending module 1410, configured to send, to a relay terminal, a network coverage status and/or an RRC state of the terminal device.

Optionally, the above-mentioned first sending module 1410 sends, to the relay terminal, the network coverage status and/or the RRC state of the terminal device through a PC5-RRC signaling or a PC5-S signaling.

Optionally, in response to the terminal device being outside a network coverage and outside a relay coverage, the network coverage status is configured for the relay terminal to determine not to perform parameter forwarding for the terminal device.

Optionally, the above-mentioned situation in which the terminal device is outside the relay coverage includes:
a strength and/or quality of signal received by the terminal device from the relay terminal is equal to or lower than a predetermined threshold.

Optionally, in response to the terminal device being within a network coverage and/or a relay coverage and being in an RRC idle state or an RRC inactive state, the network coverage status and the RRC state are configured for the relay terminal to determine to perform parameter forwarding through an SIB for the terminal device.

Optionally, when the terminal device is within the relay coverage, the SIB is an SIB relayed by the relay terminal.

Optionally, in response to the terminal device being within a network coverage and/or a relay coverage and being in an RRC connected state, the network coverage status and the RRC state are configured for the relay terminal to determine to perform parameter forwarding through a dedicated RRC signaling parameter for the terminal device. Optionally, when the terminal device is within the relay coverage, the dedicated RRC signaling is a dedicated RRC signaling relayed by the relay terminal.

Optionally, the above-mentioned situation that the terminal device is within the relay coverage includes: a strength and/or quality of signal received by the terminal device from the relay terminal is equal to or higher than a predetermined threshold. Optionally, in response to the terminal device being outside a network coverage, the network coverage status is configured for the relay terminal to determine not to perform parameter forwarding for the terminal device.

Optionally, the situation that the terminal device is outside the network coverage includes: a strength and/or quality of signal received by the terminal device from a network device is equal to or lower than a predetermined threshold.

Optionally, in response to the terminal device being within a network coverage and being in an RRC idle state or an RRC inactive state, the network coverage status and the RRC state are configured for the relay terminal to determine to perform parameter forwarding through an SIB for the terminal device.

Optionally, in the above-mentioned situation that the terminal device is within the network coverage and the terminal device is in a non-direct connection state, the SIB is an SIB relayed by the relay terminal.

Optionally, in response to the terminal device being within a network coverage and being in an RRC connected state, the network coverage status and the RRC state are configured for the relay terminal to determine to perform parameter forwarding through a dedicated RRC signaling for the terminal device.

Optionally, when the terminal device is within the network coverage and the terminal device is in a non-direct connection state, the dedicated RRC signaling is a dedicated RRC signaling relayed by the relay terminal. Optionally, the above-mentioned situation that the terminal device is within the network coverage includes: a strength and/or quality of signal received from a network device is equal to or higher than a predetermined threshold.

It should be understood that the above and other operations and/or functions of the modules in the terminal device according to some embodiments of this application are respectively configured to implement the corresponding process of the terminal device in the method 600 of FIG. 6, and are not repeated here for brevity.

Some embodiments of this application also propose a network device. FIG. 15 is a schematic block diagram of a network device 1500 according to some embodiments of this application, including:
a third determining module 1510, configured to determine whether to send a parameter for a remote terminal according to a network coverage status and/or an RRC state of the remote terminal.

Optionally, the above-mentioned third determining module 1510 is configured to, in response to the remote terminal being outside a network coverage and outside a relay coverage, determine not to send the parameter for the remote terminal.

Optionally, the situation that the remote terminal is outside the relay coverage includes: a strength and/or quality of signal received by the remote terminal from a relay terminal is equal to or lower than a predetermined threshold.

Optionally, the above-mentioned third determining module 1510 is configured to, in response to the remote terminal satisfying following conditions, determine to send the parameter through a system information block (SIB) for the remote terminal: the remote terminal is within a network coverage and/or a relay coverage; and the remote terminal is in an RRC idle state or an RRC inactive state.

Optionally, when the remote terminal is within the relay coverage, the SIB is an SIB relayed by the relay terminal.

Optionally, the above-mentioned third determining module 1510 is configured to, in response to the remote terminal satisfying following conditions, determine to send the parameter through a dedicated RRC signaling for the remote terminal:
the remote terminal is within a network coverage and/or a relay coverage; and,
the remote terminal is in an RRC connected state.

Optionally, when the remote terminal is within the relay coverage, the dedicated RRC signaling is a dedicated RRC signaling relayed by the relay terminal.

Optionally, the above-mentioned situation that the remote terminal is within the relay coverage includes:
a strength and/or quality of signal received by the remote terminal from a relay terminal is equal to or higher than a predetermined threshold.

Optionally, the above-mentioned third determining module 1510 is configured to, in response to the remote terminal being outside a network coverage, determine not to send the parameter for the remote terminal.

Optionally, the above-mentioned situation that the remote terminal is outside the network coverage includes:
a strength and/or quality of signal received by the remote terminal from the network device is equal to or lower than a predetermined threshold.

Optionally, the above-mentioned third determining module 1510 is configured to, in response to the remote terminal satisfying following conditions, determine to send the parameter through an SIB for the remote terminal:
the remote terminal is within a network coverage; and the remote terminal is in an RRC idle state or an RRC inactive state.

Optionally, when the remote terminal is within the network coverage and the remote terminal is in a non-direct connection state, the SIB is an SIB relayed by the relay terminal.

Optionally, the above-mentioned third determining module 1510 is configured to, in response to the remote terminal being within a network coverage and being in an RRC connected state, determine to send the parameter through a dedicated RRC signaling for the remote terminal.

Optionally, when the remote terminal is within the network coverage and the remote terminal is in a non-direct connection state, the dedicated RRC signaling is a dedicated RRC signaling relayed by the relay terminal.

Optionally, the above-mentioned situation that the remote terminal is within the network coverage includes:
a strength and/or quality of signal received by the remote terminal from the network device is equal to or higher than a predetermined threshold.

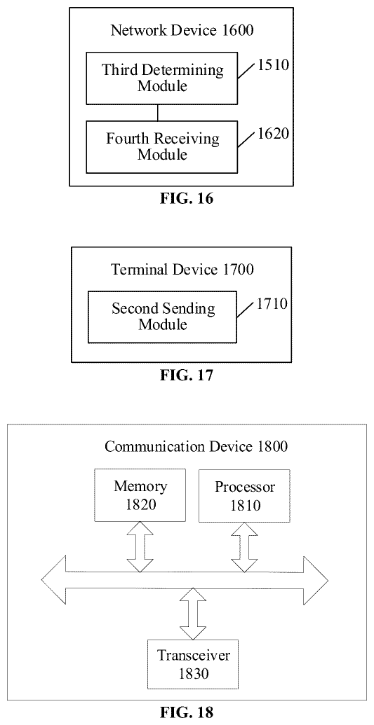

FIG. 16 is a schematic block diagram of a network device 1600 according to some embodiments of this application. The network device 1600 includes the above-mentioned third determining module 1510, and may further include:
a fourth receiving module 1620, configured to receive the network coverage status and/or the RRC state of the remote terminal.

Optionally, the above-mentioned fourth receiving module 1620 is configured to receive the network coverage status and/or the RRC state of the remote terminal from the remote terminal or a relay terminal.

Optionally, the above-mentioned fourth receiving module 1620 is configured to: receive, from the relay terminal, the network coverage status and/or the RRC state of the remote terminal transparently transmitted by the relay terminal; or receive the network coverage status and/or the RRC state of the remote terminal sent by the relay terminal by means of SUI.

It should be understood that the above and other operations and/or functions of the modules in the terminal device according to some embodiments of this application are respectively configured to implement the corresponding process of the network device in the method 800 of FIG. 8, and are not repeated here for brevity.

Some embodiments of this application further propose a terminal device, which can be used as a remote terminal. FIG. 17 is a schematic block diagram of a terminal device 1700 according to some embodiments of this application, including:
a second sending module 1710, configured to send a network coverage status and/or an RRC state of the terminal device over network.

Optionally, the above-mentioned second sending module 1710 sends the network coverage status and/or the RRC state of the terminal device to a relay terminal through a PC5-RRC signaling or a PC5-S signaling.

Optionally, the above-mentioned second sending module 1710 sends the network coverage status and/or the RRC state of the terminal device to a network device through a physical layer signaling, a MAC CE or an RRC signaling.

Optionally, the above-mentioned RRC signaling includes sidelink UE information.

Optionally, in response to the terminal device being outside a network coverage and outside a relay coverage, the network coverage status is configured for a network device to determine not to send a parameter for the terminal device.

Optionally, the above-mentioned situation in which the terminal device is outside the relay coverage includes:
a strength and/or quality of signal received by the terminal device from a relay terminal is equal to or lower than a predetermined threshold.

Optionally, in response to the terminal device being within a network coverage and/or a relay coverage and being in an RRC idle state or an RRC inactive state, the network coverage status and the RRC state are configured for a network device to determine to send a parameter through an SIB for the terminal device.

Optionally, when the terminal device is within the relay coverage, the SIB is an SIB relayed by the relay terminal.

Optionally, in response to the terminal device being within a network coverage and/or a relay coverage and being in an RRC connected state, the network coverage status and the RRC state are configured for a network device to determine to send a parameter through a dedicated RRC signaling for the terminal device.

Optionally, when the terminal device is within the relay coverage, the dedicated RRC signaling is a dedicated RRC signaling relayed by the relay terminal.

Optionally, the above-mentioned situation that the terminal device is within the relay coverage includes:
a strength and/or quality of signal received by the terminal device from a relay terminal is equal to or higher than a predetermined threshold.

Optionally, in response to the terminal device being outside a network coverage, the network coverage status is configured for a network device to determine not to send a parameter to the terminal device.

Optionally, the above-mentioned situation in which the terminal device is outside the network coverage includes:
a strength and/or quality of signal received by the terminal device from a network device is equal to or lower than a predetermined threshold.

Optionally, in response to the terminal device being within a network coverage and being in an RRC idle state or an RRC inactive state, the network coverage status and the RRC state are configured for a network device to determine to send a parameter through an SIB for the terminal device.

Optionally, when the terminal device is within the network coverage and the terminal device is in a non-direct connection state, the SIB is an SIB relayed by the relay terminal.

Optionally, in response to the terminal device being within a network coverage and being in an RRC connected state, the network coverage status and the RRC state are configured for a network device to determine to send a parameter through a dedicated RRC signaling for the terminal device.

Optionally, when the terminal device is within the network coverage and the terminal device is in a non-direct connection state, the dedicated RRC signaling is a dedicated RRC signaling relayed by the relay terminal.

Optionally, the above-mentioned situation that the terminal device is within the network coverage includes:
a strength and/or quality of signal received by the terminal device from a network device is equal to or higher than a predetermined threshold.

It should be understood that the above and other operations and/or functions of the modules in the terminal device according to some embodiments of this application are respectively configured to implement the corresponding process of the terminal device in the method 900 of FIG. 9, and are not repeated here for brevity.

It should be noted that the functions described with respect to each module (submodule, unit, or component, etc.) in the terminal device and the network device according to some embodiments of this application may be implemented by different modules (submodule, unit, or component, etc.), or may be implemented by the same module (submodule, unit or component, etc.). For example, the first sending module and the second sending module may be different modules, or may be the same module, both of which can be implemented to achieve corresponding functions in some embodiments of this application. In addition, the sending module and the receiving module in some embodiments of this application may be implemented by a transceiver of the device, and some or all of the other modules may be implemented by a processor of the device.

FIG. 18 is a schematic block diagram of a communication device 1800 according to some embodiments of this application. The communication device 1800 shown in FIG. 18 includes a processor 1810, and the processor 1810 can call and run a computer program from a memory to implement the method according to some embodiments of this application.

Optionally, as shown in FIG. 18, the communication device 1800 may further include a memory 1820. The processor 1810 may call and run the computer program from the memory 1820 to implement the methods according to some embodiments of this application.

The memory 1820 may be a separate device independent of the processor 1810, or may be integrated in the processor 1810.

Optionally, as shown in FIG. 18, the communication device 1800 may further include a transceiver 1830, and the processor 1810 may control the transceiver 1830 to communicate with other devices, specifically, may send information or data to other devices, or receive information or data sent by the other devices.

In some embodiments, the transceiver 1830 may include a transmitter and a receiver. The transceiver 1830 may further include antennas, and the number of the antennas may be one or more.

Optionally, the communication device 1800 may be the terminal device according to some embodiments of this application, and the communication device 1800 may implement the corresponding processes implemented by the terminal device in each method according to some embodiments of this application, which is not repeated here for brevity.

Optionally, the communication device 1800 may be the network device according to some embodiments of this application, and the communication device 1800 may implement the corresponding processes implemented by the network device in each method according to some embodiments of this application, which is not repeated here for brevity.

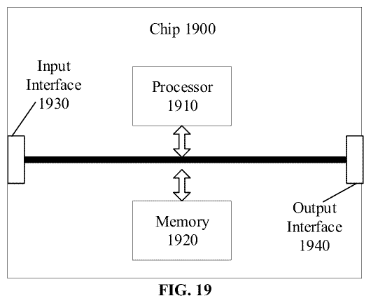

FIG. 19 is a schematic block diagram of a chip 1900 according to some embodiments of this application. The chip 1900 shown in FIG. 19 includes a processor 1910, and the processor 1910 can call and run a computer program from a memory to implement the method according to some embodiments of this application.

Optionally, as shown in FIG. 19, the chip 1900 may further include a memory 1920. The processor 1910 may call and run the computer program from the memory 1920 to implement the methods according to some embodiments of this application.

The memory 1920 may be a separate device independent of the processor 1910, or may be integrated in the processor 1910.

Optionally, the chip 1900 may further include an input interface 1930. The processor 1910 may control the input interface 1930 to communicate with other devices or chips, and specifically, may acquire information or data sent by other devices or chips.

Optionally, the chip 1900 may further include an output interface 1940. The processor 1910 may control the output interface 1940 to communicate with other devices or chips, and specifically, may output information or data to other devices or chips.

Optionally, the chip may be applicable to the terminal device according to some embodiments of this application, and the chip may implement the corresponding processes implemented by the terminal device in each method according to some embodiments of this application, which is not repeated here for brevity.

Optionally, the chip may be applicable to the network device according to some embodiments of this application, and the chip may implement the corresponding processes implemented by the network device in each method according to some embodiments of this application, which is not repeated here for brevity.

It should be understood that the chip mentioned in some embodiments of this application may also be referred to as a system-level chip, a system chip, a chip system, a system-on-chip, or the like.

The processor mentioned above may be a general-purpose processor, a digital signal processor (DSP), a field programmable gate array (FPGA), an application specific integrated circuit (ASIC) or other programmable logic devices, transistor logic devices, discrete hardware components, and the like. The general-purpose processor mentioned above may be a microprocessor or any conventional processor or the like.

The memory mentioned above may be either volatile memory or non-volatile memory, or may include both volatile and non-volatile memory. The non-volatile memory may be read-only memory (ROM), programmable read-only memory (PROM), erasable programmable read-only memory (EPROM), electrically EPROM (EEPROM) or flash memory. Volatile memory may be random access memory (RAM).

It should be understood that the above memory is an example but not a limitative description, for example, the memory in some embodiments of this application may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), and the like. In other words, the memory in some embodiments of this application is intended to include but not limited to these and any other suitable types of memory.

In the above-mentioned embodiments, it may be implemented in whole or in part by software, hardware, firmware or any combination thereof. When implemented in software, it can be implemented in whole or in part in the form of a computer program product. The computer program product includes one or more computer instructions. When the computer program instructions are loaded and executed on a computer, all or part of the processes or functions described in some embodiments of this application are generated. The computer may be a general purpose computer, a special purpose computer, a computer network, or other programmable devices. The computer instructions may be stored on or transmitted from one computer readable storage medium to another computer readable storage medium. For example, the computer instructions may be transmitted over a wire (e.g., coaxial cable, optical fiber, digital subscriber line (DSL)) or wireless (e.g., infrared, wireless, microwave, etc.) means from a website site, computer, server or data center to another website site, computer, server or data center. The computer-readable storage medium can be any available medium that can be accessed by a computer or a data storage device such as a server, data center, and the like that includes one or more available medium integrated. The available medium may be a magnetic medium (e.g., a floppy disk, a hard disk, a magnetic tape), an optical medium (e.g., a DVD), or a semiconductor medium (e.g., a Solid State Disk (SSD)), and the like.

It should be understood that, in various embodiments of this application, the size of the sequence numbers in the above-mentioned processes does not mean the sequence of execution, and the execution sequence of each process should be determined by its functions and internal logic, and should not constitute any limitation on implementation of embodiments of this application. Those skilled in the art can clearly understand that, for the convenience and brevity of description, the specific working process of the above-described systems, devices and units may refer to the corresponding processes in the foregoing method embodiments, which will not be repeated here.

The above are only specific embodiments of this application, but the protection scope of this application is not limited thereto. Any person skilled in the art can easily think of changes or substitutions within the technical scope disclosed in this application, which should fall within the protection scope of this application. Therefore, the protection scope of this application shall be subject to the protection scope of the claims.

What is claimed is:

1. A parameter configuration method, being applicable to a remote terminal and comprising:
determining a parameter used by the remote terminal according to a network coverage status and/or a radio resource control (RRC) state of the remote terminal.

2. The method according to claim 1, wherein determining the parameter used by the remote terminal according to the network coverage status and/or the RRC state of the remote terminal comprises:
in response to the remote terminal being outside a network coverage and outside a relay coverage, determining that the remote terminal uses a preconfigured parameter.

3. The method according to claim 2, wherein the remote terminal being outside the relay coverage comprises:
a strength and/or quality of signal received by the remote terminal from a relay terminal is equal to or lower than a predetermined threshold.

4. The method according to claim 1, wherein determining the parameter used by the remote terminal according to the network coverage status and/or the RRC state of the remote terminal comprises:
in response to the remote terminal satisfying at least one of following conditions, determining that the remote terminal uses a parameter broadcast in a system information block (SIB):
the remote terminal is within a relay coverage;
the remote terminal is in an RRC idle state or an RRC inactive state; and
the remote terminal has acquired the parameter broadcast in the SIB.

5. The method according to claim 4, wherein, in response to the remote terminal being within the relay coverage, the SIB is relayed by a relay terminal.

6. The method according to claim 1, wherein determining the parameter used by the remote terminal according to the network coverage status and/or the RRC state of the remote terminal comprises:
in response to the remote terminal satisfying at least one of following conditions, determining that the remote terminal uses a parameter configured by a dedicated RRC signaling:
the remote terminal is within a network coverage and/or a relay coverage;
the remote terminal is in an RRC connected state; and
the remote terminal has acquired the parameter configured by the dedicated RRC signaling.

7. The method according to claim 6, wherein, in response to the remote terminal being within the relay coverage, the dedicated RRC signaling is relayed by a relay terminal.

8. A parameter configuration method, being applicable to a network device and comprising:
determining, by the network device, whether to send a parameter for a remote terminal according to a network coverage status and/or a radio resource control (RRC) state of the remote terminal.

9. The method according to claim 8, wherein determining whether to send the parameter for the remote terminal according to the network coverage status and/or the RRC state of the remote terminal comprises:
in response to the remote terminal being outside a network coverage and outside a relay coverage, determining not to send the parameter for the remote terminal.

10. The method according to claim 9, wherein the remote terminal being outside the relay coverage comprises:
a strength and/or quality of signal received by the remote terminal from a relay terminal is equal to or lower than a predetermined threshold.

11. The method according to claim 8, wherein determining whether to send the parameter for the remote terminal according to the network coverage status and/or the RRC state of the remote terminal comprises:
in response to the remote terminal satisfying following conditions, determining to send the parameter through a system information block (SIB) for the remote terminal:
the remote terminal is within a relay coverage; and
the remote terminal is in an RRC idle state or an RRC inactive state.

12. The method according to claim 11, wherein, in response to the remote terminal being within the relay coverage, the SIB is relayed by a relay terminal.

13. The method according to claim 8, wherein determining whether to send the parameter for the remote terminal according to the network coverage status and/or the RRC state of the remote terminal comprises:
in response to the remote terminal satisfying following conditions, determining to send the parameter through a dedicated RRC signaling for the remote terminal:
the remote terminal is within a network coverage and/or a relay coverage; and,
the remote terminal is in an RRC connected state.

14. A terminal device, serving as a remote terminal and comprising:
a processor, a memory and a transceiver;
wherein the memory is configured to store a computer program, and
wherein the processor, through invoking and executing the computer program stored in the memory and controlling the transceiver, is configured to determine a parameter used by the terminal device according to a network coverage status and/or a radio resource control (RRC) state of the terminal device.

15. The terminal device according to claim 14, wherein the processor is configured to, in response to the terminal device being outside a network coverage and outside a relay coverage, determine that the terminal device uses a preconfigured parameter.

16. The terminal device according to claim 15, wherein the terminal device being outside the relay coverage comprises:
a strength and/or quality of signal received by the terminal device from a relay terminal is equal to or lower than a predetermined threshold.

17. The terminal device according to claim 14, wherein the processor is configured to, in response to the terminal device satisfying following conditions, determine that the terminal device uses a parameter broadcast in a system information block (SIB):
the terminal device is within a relay coverage; and
the terminal device is in an RRC idle state or an RRC inactive state.

18. The terminal device according to claim 17, wherein, in response to the terminal device being within the relay coverage, the SIB is relayed by a relay terminal.

19. The terminal device according to claim 14, wherein the processor is configured to, in response to the terminal device satisfying following conditions, determine that the terminal device uses a parameter configured by a dedicated RRC signaling:
the terminal device is within a network coverage and/or a relay coverage; and
the terminal device is in an RRC connected state.

20. The terminal device according to claim 19, wherein, in response to the terminal device being within the relay coverage, the dedicated RRC signaling is relayed by a relay terminal.
